(19) United States
(12) Patent Application Publication
(10) Pub. No.: US 2025/0053055 A1
(43) Pub. Date: Feb. 13, 2025

(54) ELECTROCHROMIC ELEMENT, SPECTACLE LENS, AND WINDOW MATERIAL

(71) Applicant: CANON KABUSHIKI KAISHA, Tokyo (JP)

(72) Inventor: KAZUYA MIYAZAKI, Tokyo (JP)

(21) Appl. No.: 18/933,264

(22) Filed: Oct. 31, 2024

Related U.S. Application Data
(63) Continuation of application No. PCT/JP2023/016218, filed on Apr. 25, 2023.

(30) Foreign Application Priority Data
May 2, 2022 (JP) 2022-075799

(51) Int. Cl. G02F 1/1516; E06B 9/24; G02C 7/10; G02F 1/1514

(52) U.S. Cl. CPC G02F 1/15165; E06B 9/24; E06B 2009/2464; G02C 7/101; G02F 2001/15145

(57) ABSTRACT

An electrochromic element includes: an element structure including a pair of electrodes and an electrochromic layer arranged between the pair of electrodes, in which a chromaticity in a decolored state is in a range of a chroma C*=6 to 15 and a hue angle h*=105° to 130° in a chromaticity diagram of a CIE 1976 color space; and a colorant layer provided in the element structure and having a main absorption peak with an absorbance of 0.04 to 0.12 and a full width at half maximum of 20 to 60 nm between 550 nm and 570 nm in wavelength.

### CROSS-REFERENCE TO RELATED APPLICATIONS

This application is a Continuation of International Patent Application No. PCT/JP2023/016218, filed Apr. 25, 2023, which claims the benefit of Japanese Patent Application No. 2022-075799, filed May 2, 2022, both of which are hereby incorporated by reference herein in their entirety.

### BACKGROUND OF THE INVENTION

### Field of the Invention

The present invention relates to an electrochromic element, a spectacle lens, and a window material.

### Description of the Related Art

An electrochromic (hereinafter sometimes referred to as “EC”) element is an optical element having a pair of electrodes and an EC layer arranged between the electrodes, which adjusts the hue and light quantity of a visible light band by oxidizing or reducing a compound in the EC layer by applying a voltage between the pair of electrodes.

The EC elements has so far been applied to products such as dimming windows in aircraft and antiglare mirrors in automobiles. In recent years, an application of an EC element to a variable ND filter in an imaging apparatus, a dimming lens of spectacles, and the like has been attempted. The EC element has a wide dynamic range in terms of dimming performance. Therefore, when the EC element is used as a dimming lens for spectacles, it does not need to be removed in dark places like conventional sunglasses and can be worn at all times. While the ability to wear spectacles in any scene is a great advantage for users, the performance requirements for products are more demanding. For example, the color of the spectacle lens is required to be substantially achromatic so that there is no attenuation of the transmittance of a specific color. Also, for example, in order to drive at night or at twilight, the luminous transmittance of the spectacle lens is required to be 75% or more.

Japanese Patent Application Laid-Open No. 2013-228520 discloses a technique in which a transparent plastic spectacle lens is provided with a layer containing a colorant having a main absorption peak with a full width at half maximum of 40 nm to 140 nm between 380 nm and 650 nm in wavelength in order to provide antiglare properties.

However, in the technique disclosed in Japanese Patent Application Laid-Open No. 2013-228520, since the layer containing the colorant is provided on the transparent spectacle lens of a substantially achromatic color to dim the color, it is difficult to achieve substantial achromatization of the EC element having a color in a decolored state, and it is also difficult to suppress a decrease in the transmittance of the EC element to a small degree.

### SUMMARY OF THE INVENTION

Therefore, in view of the above problems, it is an object of the present invention to provide an EC element, a spectacle lens, and a window material capable of achieving substantial achromatization of the EC element having a color in a decolored state while suppressing a decrease in the transmittance of the EC element to a small degree.

According to one aspect of the present invention, there is provided an electrochromic element including: an element structure including a pair of electrodes and an electrochromic layer arranged between the pair of electrodes, in which a chromaticity in a decolored state is in a range of a chroma C*=6 to 15 and a hue angle h*=105° to 130° in a chromaticity diagram of a CIE 1976 color space; and a colorant layer provided in the element structure and having a main absorption peak with an absorbance of 0.04 to 0.12 and a full width at half maximum of 20 to 60 nm between 550 nm and 570 nm in wavelength.

Further features of the present invention will become apparent from the following description of exemplary embodiments with reference to the attached drawings.

### BRIEF DESCRIPTION OF THE DRAWINGS

FIG. 1 is a schematic cross-sectional view illustrating an EC element according to an embodiment of the present invention.

FIG. 2 is a graph showing the chromaticity of a conventional EC element in a decolored state in the CIE 1976 color space.

FIG. 3 is a graph showing the correlation between the chroma C* and the luminous transmittance Tv of the EC element when the absorption spectrum shape is changed.

FIG. 4 is a graph showing the spectral transmittances of an element 1 formed without a colorant layer and elements 1A, 1B, 1C, 1D, 1E, 1a, and 1b each formed with a colorant layer.

FIG. 5 is a graph showing the correlation between the chroma C* and the luminous transmittance Tv of the element 1 formed without the colorant layer and the elements 1A, 1B, 1C, 1D, 1E, 1a, 1b each formed with the colorant layer.

FIG. 6 is a graph showing the spectral transmittances of an element 2 formed without a colorant layer and the elements 2A, 2B, 2C, 2D, 2E, 2a, and 2b each formed with a colorant layer.

FIG. 7 is a graph showing the correlation between the chroma C* and the luminous transmittance Tv of the element 2 formed without the colorant layer and the elements 2A, 2B, 2C, 2D, 2E, 2a, and 2b each formed with the colorant layer.

FIG. 8 is a graph showing the spectral transmittances of an element 3 formed without a colorant layer and elements 3A, 3B, 3C, 3D, 3E, 3a, and 3b each formed with a colorant layer.

FIG. 9 is a graph showing the correlation between the chroma C* and the luminous transmittance Tv of the element 3 formed without the colorant layer and the elements 3A, 3B, 3C, 3D, 3E, 3a, and 3b each formed with the colorant layer.

FIG. 10 is a schematic cross-sectional view illustrating a dimming spectacle lens using the EC element according to the embodiment of the present invention.

FIG. 11A is a schematic view illustrating a dimming window using the EC element according to the embodiment of the present invention.

FIG. 11B is a schematic view illustrating the dimming window using the EC element according to the embodiment of the present invention.

### DESCRIPTION OF THE EMBODIMENTS

Hereinafter, the configuration of an EC element according to the present invention will be described in detail with a suitable embodiment as an example. However, the configuration, the relative arrangement and the like described in the present embodiment are not intended to limit the scope of the present invention unless otherwise described.

An EC element according to an embodiment of the present invention is an electrochromic element that includes: an element structure including a pair of electrodes and an electrochromic layer arranged between the pair of electrodes, in which a chromaticity in a decolored state is in a range of a chroma C*=6 to 15 and a hue angle h*=105° to 130° in a chromaticity diagram of a CIE 1976 color space; and a colorant layer provided in the element structure and having a main absorption peak with an absorbance of 0.04 to 0.12 and a full width at half maximum of 20 to 60 nm between 550 nm and 570 nm in wavelength.

### [Composition and Member of EC Element]

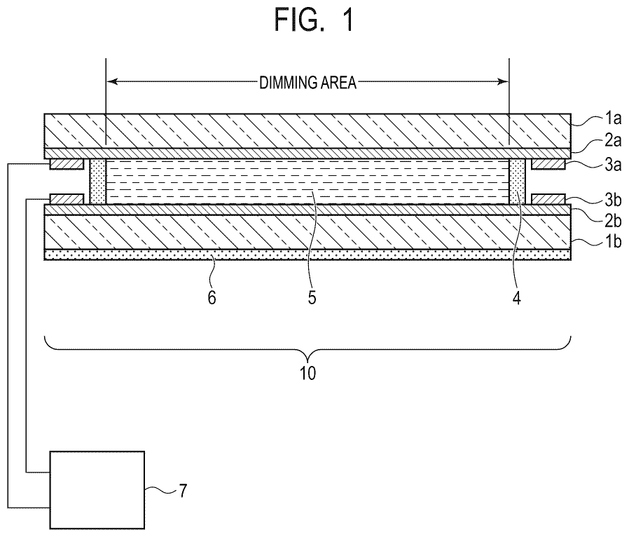

First, the configuration of an EC element according to an embodiment of the present invention will be described with reference to FIG. 1. FIG. 1 is a schematic cross-sectional view illustrating the EC element 10 according to the present embodiment.

As illustrated in FIG. 1, the EC element 10 has a pair of substrates 1a and 1b, a pair of transparent electrodes 2a and 2b, a pair of bus wirings 3a and 3b, a seal 4, an EC layer 5, and a colorant layer 6. The transparent electrode 2a is formed on one surface of the substrate 1a. The transparent electrode 2b is formed on one surface of the substrate 1b. The substrate la and the substrate 1b are arranged with the seal 4 therebetween so that the transparent electrode 2a and the transparent electrode 2b face each other. The EC layer 5 is arranged in a space defined by the substrate 1a on which the transparent electrode 2a is formed, the substrate 1b on which the transparent electrode 2b is formed, and the seal 4. The colorant layer 6 is provided on the other surface of the substrate 1b. On the outer periphery of the seal 4, the bus wirings 3a and 3b for realizing uniform application of a voltage to the EC layer 5 are formed on the pair of transparent electrodes 2a and 2b so as to surround a dimming area of the EC element 10, respectively.

A driving circuit 7 is electrically connected to the bus wirings 3a and 3b of the EC element 10. The driving circuit 7 is electrically connected to the transparent electrodes 2a and 2b via the bus wirings 3a and 3b, and applies a driving voltage to the transparent electrodes 2a and 2b.

Next, the members constituting the EC element 10 according to the present embodiment will be described in detail.

The EC layer 5 includes an EC compound that exhibits electrochromic characteristics (EC characteristics). The EC layer 5 is preferably a solution layer in which an EC compound is dissolved in an organic solvent. The solution layer may contain an electrolyte. Further, the solution layer may contain a colorant, which will be described later. In this case, the EC layer 5 also serves as the colorant layer 6. A method of forming the EC layer 5 is not particularly limited, but includes a method of injecting a liquid containing the EC compound prepared in advance by a vacuum injection method, an ODF method, an air injection method, a meniscus method, or the like into a gap formed between the pair of transparent electrodes 2a and 2b.

The EC compound contained in the EC layer 5 may be an organic compound or an inorganic compound, but is preferably an organic compound. The EC compound may be an anodic electrochromic compound that is colored from a transparent state by an oxidation reaction, or a cathodic electrochromic compound that is colored from a transparent state by a reduction reaction. Both of the anodic EC compound and the cathodic EC compound may be used as the EC compounds included in the EC layer 5. It is preferable to use both of the anodic EC compound and the cathodic EC compound because the coloring efficiency with respect to current is higher. In this specification, an EC element including both of the anodic EC compound and the cathodic EC compound is referred to as a complementary EC element. The anodic EC compound is also referred to as an anodic material, and the cathodic EC compound is also referred to as a cathodic material.

When the complementary EC element is driven, electrons are extracted from the EC compound by an oxidation reaction at one of the transparent electrodes 2a and 2b, and electrons are received by the EC compound by a reduction reaction at the other electrode. Radical cations may be formed from neutral molecules by the oxidation reaction. Radical anions may be formed from neutral molecules by a reduction reaction, or radical cations may be formed from dicationic molecules. In the complementary EC element, since the EC compound is colored at both of the pair of transparent electrodes 2a and 2b on the pair of substrates 1a and 1b, it is preferable to adopt the complementary EC element when a large optical density change is required during coloring.

Examples of the organic EC compounds include conductive polymers such as polythiophene, polyaniline, and the like, and organic low molecular weight compounds such as viologen compounds, anthraquinone compounds, oligothiophene derivatives, phenazine derivatives, and the like.

The EC layer 5 may have only one type of the EC compound or multiple types of the EC compounds. When the EC layer 5 contains multiple types of the EC compounds, it is preferable that the difference in the redox potential of the EC compounds is small. When the EC layer 5 contains multiple types of the EC compounds, the EC layer 5 may contain four or more types of the EC compounds, including the anodic EC compounds and the cathodic EC compounds. The EC layer 5 may contain five or more types of the EC compounds. When the EC layer 5 contains multiple types of the EC compounds, the difference in the redox potentials of the plurality of anodic materials may be within 60 m V, and the difference in the redox potentials of the plurality of the cathodic materials may be within 60 mV.

When the EC layer 5 contains multiple types of the EC compounds, the multiple types of the EC compounds may include a compound having an absorption peak at 400 nm or more and 500 nm or less, a compound having an absorption peak at 500 nm or more and 650 nm or less, and a compound having an absorption peak at 650 nm or more. The absorption peak is defined as having a full width at half maximum of 20 nm or more. The state of the EC compound when absorbing light may be an oxidized state, a reduced state, or a neutral state.

The EC layer 5 may contain an electrolyte. The electrolyte is not limited as long as it is an ion-dissociable salt and exhibits good solubility in a solvent and high compatibility in a solid electrolyte. Electrolytes with electron-donating properties are especially preferred as the electrolyte in the EC layer 5. These electrolytes may be referred to as supporting electrolytes. Examples of the electrolyte include inorganic ion salts such as various alkali metal salts and alkaline earth metal salts, quaternary ammonium salts, cyclic quaternary ammonium salts, and the like. Specifically, examples of the electrolyte include alkali metal salts of Li, Na, and K such as LiClO₄, LiSCN, LiBF₄, LiAsF₆, LiCF₃SO₃, LiPF₆, LiI, NaI, NaSCN, NaClO₄, NaBF₄, NaAsF₆, KSCN, KCl, and the like, and quaternary ammonium salts and cyclic quaternary ammonium salts such as (CH₃)₄NBF₄, (C₂H₅)₄NBF₄, (n-C₄H₉)₄NBF₄, (n-C₄H₉)₄NPF₆, (C₂H₅)₄NBr, (C₂H₅)₄NClO₄, and (n-C₄H₉)₄NClO₄.

The solvent for dissolving the EC compound and the electrolyte is not particularly limited as long as the solvent is capable of dissolving the EC compound and the electrolyte, but is particularly preferred to have a polarity. Specifically, examples of the solvent include water, and organic polar solvents such as methanol, ethanol, propylene carbonate, ethylene carbonate, dimethyl sulfoxide, dimethoxyethane, γ-butyrolactone, γ-valerolactone, sulfolane, dimethylformamide, dimethoxyethane, tetrahydrofuran, acetonitrile, propionitrile, 3-methoxypropionitrile, benzonitrile, dimethylacetamide, methylpyrrolidinone, dioxolane, and the like.

The EC layer 5 may further contain a polymer matrix or a gelling agent. In this case, the EC layer 5 becomes a highly viscous liquid and may be gelled in some cases. Examples of the polymer include polyacrylonitrile, carboxymethylcellulose, pullulan-based polymer, polyvinyl chloride, polyethylene oxide, polypropylene oxide, polyurethane, polyacrylate, polymethacrylate, polyamide, polyacrylamide, polyester, Nafion (registered trademark), and the like, and polymethyl methacrylate (PMMA) is preferably used.

The pair of substrates 1a and 1b serve as substrates that support a structure including the transparent electrodes 2a and 2b, the EC layer 5, and the colorant layer 6, respectively. The pair of substrates 1a and 1b may be made of a material with light transmittance. “Light transmittance” means that it transmits light, which may be defined, for example, as having a light transmittance of 50% or more and 100% or less for light of the target wavelength. The target wavelength of the light here is the wavelength of the light, which is the target of the EC element 10, and is within a wavelength region of visible light as a typical example. Examples of the wavelength of the light include 380 nm or more and 780 nm or less. Note that “transparency” may also be synonymously defined as “light transmittance”.

As the pair of substrates 1a and 1b, substrates of a glass material, a resin material, or the like may be used. Examples of the glass material includes white plate glass, optical glass, alkali-free glass, chemically strengthened glass, or the like, from which a thin lightweight glass enough to be used as a spectacle lens can preferably be used. Examples of the resin material include polyethylene terephthalate resin (PET), polycarbonate (PC), allyl diglycol carbonate resin (ADC), a colorless transparent polyimide resin (PI), or the like, and a highly transparent resin having high strength and heat resistance is preferably used.

Further, the pair of substrates 1a and 1b are preferably formed or bonded with a member that shields ultraviolet rays to prevent deterioration of the EC layer 5 by ultraviolet rays. Examples of the member that shields ultraviolet rays include an ultraviolet reflecting film, an ultraviolet absorbing film, and the like.

The pair of transparent electrodes 2a and 2b have a role of controlling the coloration and decoloration of the EC layer 5 by a voltage applied thereto. The pair of transparent electrodes 2a and 2b are both made of transparent electrode materials. The EC element 10 exhibits EC characteristics by applying a voltage between the transparent electrodes 2a and 2b.

Examples of the materials of the transparent electrodes 2a and 2b include indium tin oxide alloy (ITO), fluorine-doped tin oxide (FTO), tin oxide (NESA), indium zinc oxide (IZO), graphene, and the like. In addition, a conductive polymer having improved conductivity by doping treatment or the like, such as polyaniline, polypyrrole, polythiophene, polyacetylene, polyparaphenylene, a complex of polyethylenedioxythiophene (PEDOT) and polystyrene sulfonic acid (PSS) (PEDOT: PSS), or the like, is suitably used as the material of the transparent electrodes 2a and 2b.

The EC element 10 according to the present embodiment preferably has a high transmittance in a decolored state. Therefore, a transparent material such as ITO, IZO, NESA, PEDOT: PSS, graphene or the like is particularly preferable as the material of the pair of transparent electrodes 2a and 2b on the pair of substrates 1a and 1b. These can be used as the transparent electrodes 2a and 2b in various forms such as bulk form, fine particle form, or the like. These electrodes may be used independently as the transparent electrodes 2a and 2b or in combination as the transparent electrodes 2a and 2b.

The colorant layer 6 is a layer containing a colorant having a suitable absorption spectral shape, and is a layer for achieving substantially achromatic color while suppressing a decrease in the transmittance of the EC element 10. It is preferable that the colorant layer 6 does not have EC characteristics. The colorant layer 6 may be arranged so as to include the dimming area of the EC element 10. The colorant layer 6 may be arranged on one surface of the pair of substrates 1a and 1b. In this case, the colorant layer 6 may be a thin film formed on the substrate. The colorant layer 6 may be included in the EC layer 5. That is, the EC layer 5 containing the colorant may also serve as the colorant layer 6.

Examples of the colorant contained in the colorant layer 6 include cyanine dye, methine dyes, xanthene dyes, and the like, from which the dye having a suitable absorption spectral shape can be used. The suitable spectral shape will be described in detail below, but is defined as having a main absorption peak with a full width at half maximum of 25 nm to 70 nm and an absorbance of 0.04 to 0.12 between 550 and 570 nm in wavelength. The “main absorption peak” refers to the peak having the largest absorbance among the plurality of absorption peaks.

Note that the method of forming the colorant layer 6 is not particularly limited, but when the colorant layer 6 is formed as a thin film on the surface of the substrate, the colorant layer 6 is formed by applying a solution prepared by mixing the colorant with a resin or a solvent to the substrate and heating the substrate.

The pair of bus wirings 3a and 3b formed on the pair of transparent electrodes 2a and 2b so as to surround the dimming area is formed as power supplying portions for achieving uniform voltage application to the EC layer 5 from outside the dimming area. As a material for the pair of bus wirings 3a and 3b, a low resistance metal material can be suitably used. For example, a thin film of silver, palladium, copper, aluminum, silver-palladium-copper alloy (APC), aluminum-neodymium alloy, or the like can preferably be used as the pair of bus wirings 3a and 3b. In addition, it is preferable to provide a plurality of power supplying portions for one bus wirings 3a and 3b in order to prevent voltage drop in the bus wirings.

The seal 4 seals the space between the pair of transparent electrodes 2a and 2b to hold the EC layer 5 in the space. The seal 4 is preferably a material which is chemically stable, does not permeate gas and liquid, and does not inhibit the redox reaction of the EC compound. For example, the seal 4 may be formed of an inorganic material such as glass frit, an organic material such as epoxy resin, or the like.

The EC element 10 according to the present embodiment may have a spacer having a function of defining a distance between the pair of transparent electrodes 2a and 2b. The function of the spacer may be provided by the seal 4. The spacer may be composed of an inorganic material such as silica beads, glass fibers or an organic material such as polydivinylbenzene, polyimide, polytetrafluoroethylene, fluoro rubber, epoxy resin, or the like.

### [Chromaticity of EC Element]

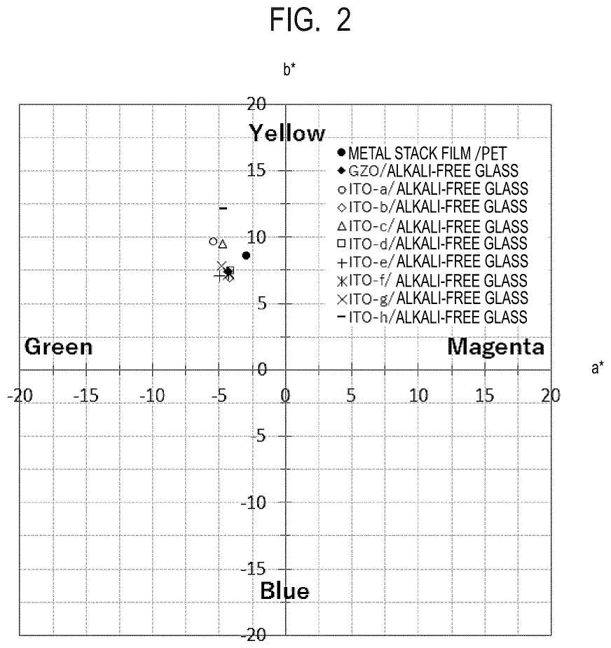

The chromaticity of the conventional EC element will be described. FIG. 2 is a graph showing the chromaticity of the conventional EC element in a decolored state in the CIE 1976 color space (L*a*b* color space). In the description of each plot in FIG. 2, the left side indicates the transparent electrode material and the right side indicates the substrate material.

As shown in FIG. 2, it can be seen that in the decolored state, the chromaticity of the conventional EC elements is concentrated at almost the same position in spite of the different types of transparent electrodes and substrates. Furthermore, it can be seen that the conventional EC elements generally exhibits a slightly strong yellow-green color. This is because the transmittance of the short wavelength side (blue side) decreases due to absorption, reflection, and the like of the transparent electrode. The conventional EC elements are considered to have substantially the same chromaticity position because they have almost the same level of the decrease. Here, the chroma C* and the hue angle h* are represented by the following expressions (1) and (2) using the chromaticity coordinates a*and b* of the L*a*b* color space, respectively.

$${C}^{*} = \sqrt{{a}^{* 2} + {b}^{{*}^{2}}} \qquad ( 1 )$$

$${h}^{*} = {tan}^{- 1} ( \frac{{b}^{*}}{{a}^{*}} ) \qquad ( 2 )$$

Then, the chromaticity range of the conventional EC elements is the following range from FIG. 2.
C*=8.1 to 12.9, h*=109° to 125°

On the other hand, in the present embodiment, by providing the colorant layer 6, it is possible to realize the optimization of color, that is, the substantial achromatization of the EC element 10 in a decolored state, while the decrease of the luminous transmittance is suppressed to a small degree. Note that the achromatization means making an EC element have C*<5.

The EC element 10 has an element structure having the pair of transparent electrodes 2a and 2b and the EC layer 5 arranged between the pair of transparent electrodes 2a and 2b. The element structure has a chromaticity in a decolored state in the range of chroma C*=6 to 15 and hue angle h*=105 to 130° in the chromaticity diagram of the CIE 1976 color space. Note that the element structure is a structure that excludes the colorant layer 6 in the EC element 10, but may or may not include the pair of substrates 1a and 1b. In the present embodiment, by providing the colorant layer 6 having a main absorption peak as described below for the element structure which is colored in a decolored state, the EC element 10 in the decolored state can be substantially achromatic while suppressing a decrease in transmittance.

[Absorption Spectrum Shape for Optimizing Color (Chroma) and Luminous Transmittance of EC element]

The range of a suitable absorption spectrum shape is obtained by calculating the color (chroma) and the luminous transmittance by superimposing Lorentz type absorption (peak wavelength λ₀, intensity A/(πγ), full width at half maximum 2γ) on the spectral transmittance of the conventional EC element. The Lorentz type absorption spectrum shape L(λ; A, λ₀, γ) can be expressed by the following expression (3).

$$L ( λ ; A , {λ}_{0} , γ ) = \frac{A}{πγ [ 1 + {( \frac{λ - {λ}_{0}}{γ} )}^{2} ]} \qquad ( 3 )$$

Here, λ, λ₀, 2γ, and A/(πγ) are as follows, respectively:
λ: wavelength
λ₀: peak wavelength
2γ: full width at half maximum (where γ is half width at half maximum)
A/(πγ): absorption intensity

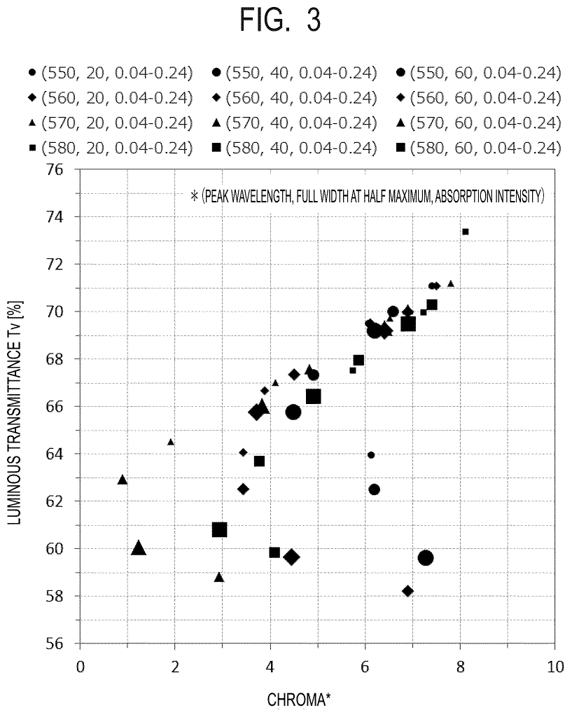

Table 1 shows the chroma and luminous transmittance of the EC element when the absorption spectrum shape is changed in the range of the peak wavelength 550 nm to 580 nm, the full width at half maximum 20 nm to 60 nm, and the absorption intensity 0.04 to 0.24, and FIG. 3 shows the correlation between the chroma and the luminous transmittance. The EC element used here uses a metal stack film as the transparent electrode and PET as the substrate (black circles in the chromaticity graph of FIG. 2). In FIG. 3, the numbers in parentheses in the description of each plot are, from left to right, the peak wavelength, the full width at half maximum and the absorption intensity.

TABLE 1
(Upper Row: Chroma *C, Lower Row: Luminous Transmittance T_{V} [%])

| | | Peak Wavelength | | | | | | | | | | | |
|---|---|---|---|---|---|---|---|---|---|---|---|---|---|
| | | 550 nm | | | 560 nm | | | 570 nm | | | 580 nm | | |
| | | Full Width at Half Maximum | | | | | | | | | | | |
| | | 20 nm | 40 nm | 60 nm | 20 nm | 40 nm | 60 nm | 20 nm | 40 nm | 60 nm | 20 nm | 40 nm | 60 nm |
| Absorption | 0.04 | 7.4 | 6.6 | 6.2 | 7.5 | 6.7 | 6.2 | 7.8 | 6.9 | 6.4 | 8.1 | 7.4 | 6.9 |
| Intensity | | 71.1 | 70.0 | 69.2 | 71.1 | 70.0 | 69.2 | 71.2 | 70.1 | 69.3 | 73.4 | 70.3 | 69.5 |
| | 0.08 | 6.1 | 4.9 | 4.5 | 6.1 | 4.5 | 3.7 | 6.5 | 4.8 | 3.8 | 7.2 | 5.9 | 4.9 |
| | | 69.5 | 67.3 | 65.8 | 69.6 | 67.3 | 65.8 | 69.7 | 67.6 | 66.0 | 70.0 | 68.0 | 66.4 |
| | 0.16 | 4.9 | 6.2 | 7.3 | 3.9 | 3.4 | 4.5 | 4.1 | 0.9 | 1.2 | 5.7 | 3.8 | 2.9 |
| | | 66.6 | 62.5 | 59.6 | 66.7 | 62.5 | 59.6 | 67.0 | 63.0 | 60.1 | 67.5 | 63.7 | 60.8 |
| | 0.24 | 6.1 | 10.6 | 12.8 | 3.4 | 6.9 | 9.3 | 1.9 | 2.9 | 5.8 | 4.7 | 4.1 | 5.3 |
| | | 64.0 | 58.2 | 54.2 | 64.1 | 58.2 | 54.2 | 64.5 | 58.8 | 54.8 | 65.3 | 59.8 | 55.9 |

As can be seen from Table 1, it is characterized that the luminous transmittance tends to decrease as the absorption intensity is increased, independent of the peak wavelength and the full width at half maximum, while the chroma has a minimum point depending on the peak wavelength and the full width at half maximum. From FIG. 3, it can be seen that if the allowable range of the human eye for coloring is set to C*<5 with respect to the chroma C*, the possible maximum luminous transmittance is about 68%. With respect to the absorption wavelength, the range of 550 nm to 570 nm is preferred because the peak wavelength of 580 nm causes a large decrease in the luminous transmittance under the condition that chroma C*<5. With regard to the full width at half maximum, the range of 20 to 60 nm is preferred because the chroma C*>5 is obtained when the full width at half maximum is less than 20 nm, and the larger full width at half maximum of more than 60 nm results in a larger decrease in the luminous transmittance. With respect to the absorption intensity, the range of 0.04 to 0.12 is preferred in consideration of the above conditions, the chroma C* and the luminous transmittance value. Therefore, the suitable range of the shape of the absorption spectrum superimposed on the EC element is 550 nm to 570 nm in the peak wavelength and 20 to 60 nm in the full width at half maximum and 0.04 to 0.12 nm in the absorption intensity.

Thus, the EC element 10 according to the present embodiment has a colorant layer 6 having a main absorption peak with an absorbance of 0.04 to 0.12 and a full width at half maximum of 20 nm to 60 nm between 550 nm and 570 nm in wavelength. In the present embodiment, the colorant layer 6 can substantially achromatize the EC element 10 in a decolored state while suppressing a decrease in transmittance.

In the EC element 10 according to the present embodiment, one or both of the pair of transparent electrodes 2a and 2b may be transparent electrodes having a chroma C* greater than 6 in a*b* coordinate. Even in such a case, the chroma C* in a*b* coordinate of the light transmitted through the EC element 10 in a decolored state becomes 6 or less by having the colorant layer 6. Note that the a*b* coordinate is a*b* coordinate in the CIE 1976 color space.

### [Examples and Comparative Examples Using Known Colorants]

Hereinafter, EC elements formed with colorant layers containing five types of known colorants in a suitable range of the absorption spectral shape defined in the present embodiment (colorants A, B, C, D, and E) and two types of known colorants deviating from the suitable range (colorants a and b) are prepared. Each colorant layer was applied to three types of EC elements having different element configurations. For each prepared EC element, the chromaticity (a*, b*, C*, and h*) and luminous transmittance Tv were evaluated. Table 2 indicates the specific contents of the five types (colorants A, B, C, D, and E) in the suitable range of the absorption spectral shape defined in the present embodiment and the two types (colorant a and b) deviating from the suitable range. The total of the seven types of colorants are SR-8913 (Chemicrea Inc.), KJ-170(ChemGenesis Inc.), Solvent Red 49 (WILLIAMS), NK-76 (Hayashibara Biochemical Laboratories, Inc.), Acid Red 94 (Tokyo Chemical Industry Co., Ltd.), Plast Violet DV-483 (Arimoto Chemical Co. Ltd.), and DC-370 (Chemicrea Inc).

TABLE 2

| | | Peak | | Full Width | |
|---|---|---|---|---|---|
| | | Wave- | | at Half | |
| | Name (Manufacturer) | length | | Maximum | |
| Colorant A | SR-8913 (Chemicrea Inc.) | 561 | nm | 50.5 | nm |
| Colorant B | KJ-170 (ChemGenesis Inc.) | 561 | nm | 29.5 | nm |
| Colorant C | Solvent Red 49 (WILLIAMS) | 564 | nm | 36 | nm |
| Colorant D | NK-76 (Hayashibara Biochemical | 565 | nm | 38 | nm |
| | Laboratories, Inc.) | | | | |
| Colorant E | Acid Red 94 (Tokyo Chemical | 565.5 | nm | 25 | nm |
| | Industry Co., Ltd.) | | | | |
| Colorant a | Plast Violet DV-483 (Arimoto | 564 | nm | 105.5 | nm |
| | Chemical Co., Ltd.) | | | | |
| Colorant b | DC-370 (Chemicrea Inc.) | 562 | nm | 85 | nm |

### EXAMPLE 1

In this example, EC elements were fabricated using a silver stacked film (TDK Corporation) having a sheet resistance of 10.8 Ω/□ as the transparent electrode and a PET film having a thickness of 125 μm as the substrate. On one surface of the PET substrate (the surface opposite to the transparent electrode), the colorant layer containing one of the five types of the colorants (colorants A, B, C, D, and E) in the suitable range of the absorption spectral shape defined in the above embodiment and the two types of the colorants (colorants a and b) deviating from the suitable range was formed. The prepared EC elements are eight types of elements including an element 1 as a comparative example, elements 1A, 1B, 1C, 1D, and 1E as examples, and elements 1a and 1b as comparative examples. No colorant layer was formed in the element 1. The colorant layer containing the colorant A was formed in the element 1A. The colorant layer containing the colorant B was formed in the element 1B. The colorant layer containing the colorant C was formed in the element 1C. The colorant layer containing the colorant D was formed in the element 1D. The colorant layer containing the colorant E was formed in the element 1E. The colorant layer containing the colorant a was formed in the element 1a. The colorant layer containing the colorant b was formed in the element 1b. Here, the absorption intensity of the colorant layer alone was adjusted so that the absorbance of all the colorants was 0.1.

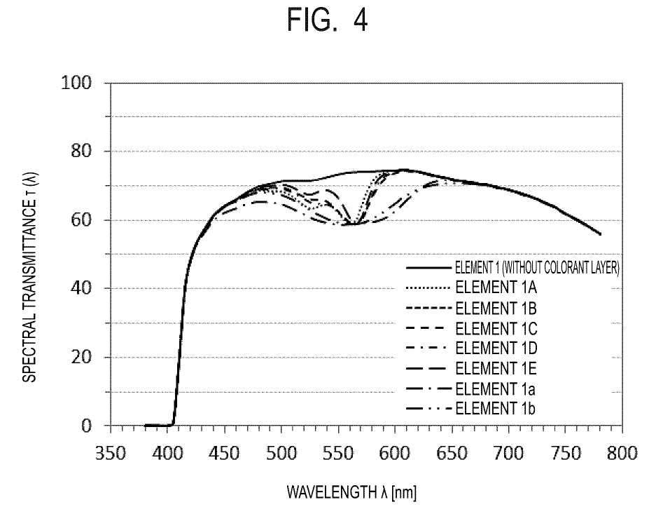

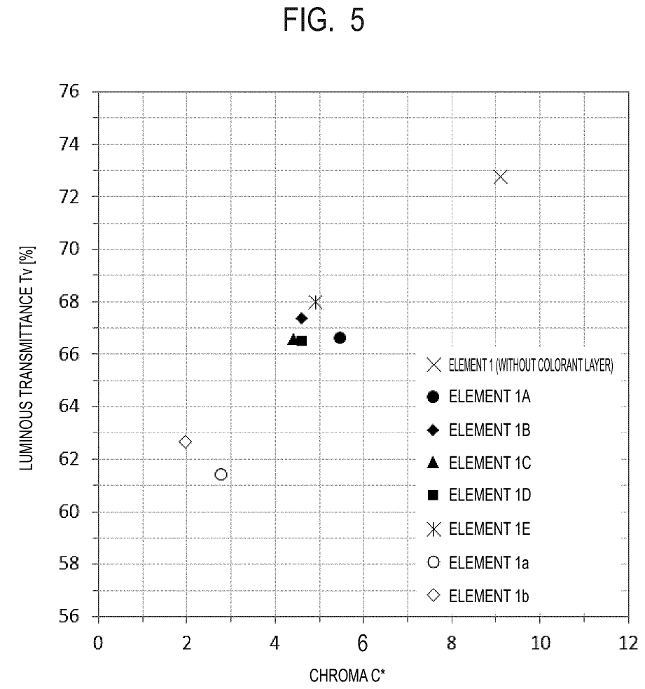

FIG. 4 shows the spectral transmittances of the element 1 without forming the colorant layer and the elements 1A, 1B, 1C, 1D, 1E, 1a, and 1b each forming the colorant layer. FIG. 5 shows the correlation between the chroma C* and the luminous transmittance Tv of these elements. Furthermore, Table 3 shows the values of the chromaticity coordinates a* and b*, the chroma C*, the hue angle h* and the luminous transmittance Tv of these elements.

TABLE 3

| | Element 1 | Element 1A | Element 1B | Element 1C | Element 1D | Element 1E | Element 1a | Element 1b |
|---|---|---|---|---|---|---|---|---|
| Colorant Layer | None | A | B | C | D | E | a | b |
| a* | −2.97 | 3.67 | 1.74 | 2.23 | 2.72 | 0.90 | 2.52 | 1.82 |
| b* | 8.60 | 4.04 | 4.26 | 3.81 | 3.70 | 4.84 | 1.17 | 0.73 |
| C* | 9.10 | 5.46 | 4.60 | 4.41 | 4.60 | 4.92 | 2.78 | 1.96 |
| h* | 109.05 | 47.74 | 67.73 | 59.61 | 53.69 | 79.47 | 25.00 | 21.73 |
| T_{V} [%] | 72.77 | 66.63 | 67.37 | 66.61 | 66.51 | 68.00 | 61.39 | 62.66 |

In the elements 1A, 1B, 1C, 1D and 1E formed with the colorant layers containing the five types of the colorants (colorants A, B, C, D, and E) in the suitable range of the absorption spectral shape defined in the above embodiment, the chroma C* could be achromatized to 4.4 to 5.5. In addition, in the elements 1A, 1B, 1C, 1D and 1E, the decrease of the luminous transmittance Tv could be suppressed as small as 4.8% to 6.3%.

On the other hand, in the elements 1a and 1b formed with the colorant layers containing the two types of the colorants (colorants a and b) deviating from the suitable range, although the chroma C* could be achromatized to less than 3, the luminous transmittance Tv was reduced by 10% or more.

### EXAMPLE 2

In this example, EC elements were fabricated using an ITO (Nippon Electric Glass Co., Ltd.) having a sheet resistance of 11.0 Ω/□ as the transparent electrode and an alkali-free glass (G-Leaf (registered trademark)) having a thickness of 100 μm as the substrate. On one surface of the substrate (the surface opposite to the transparent electrode), the colorant layer containing one of the five types of the colorants (colorants A, B, C, D, and E) in the suitable range of the absorption spectral shape defined in the above embodiment and the two types of the colorants (colorant a and b) deviating from the suitable range was formed. The prepared EC elements are eight types of elements including an element 2 as a comparative example, elements 2A, 2B, 2C, 2D and 2E as examples, and elements 2a and 2b as comparative examples. No colorant layer was formed in the element 2. The colorant layer containing the colorant A was formed in the element 2A. The colorant layer containing the colorant B was formed in the element 2B. The colorant layer containing the colorant C was formed in the element 2C. The colorant layer containing the colorant D was formed in the element 2D. The colorant layer containing the colorant E was formed in the element 2E. The colorant layer containing the colorant a was formed in the element 2a. The colorant layer containing the colorant b was formed in the element 2b. Here, the absorption intensity of the colorant layer alone was adjusted so that the absorbance of all the colorants was 0.1.

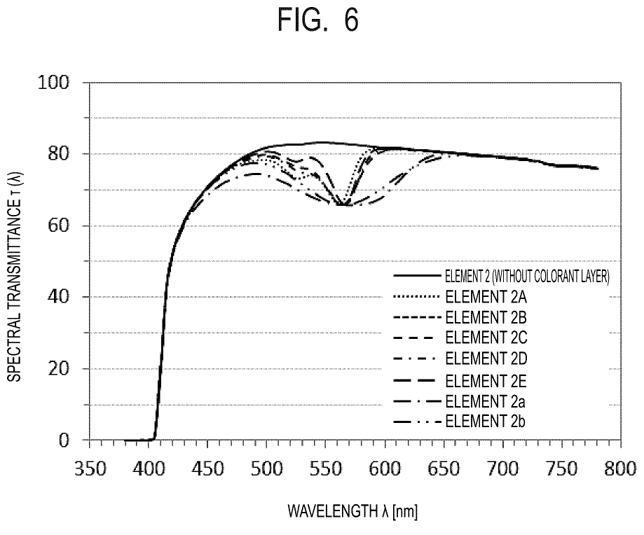

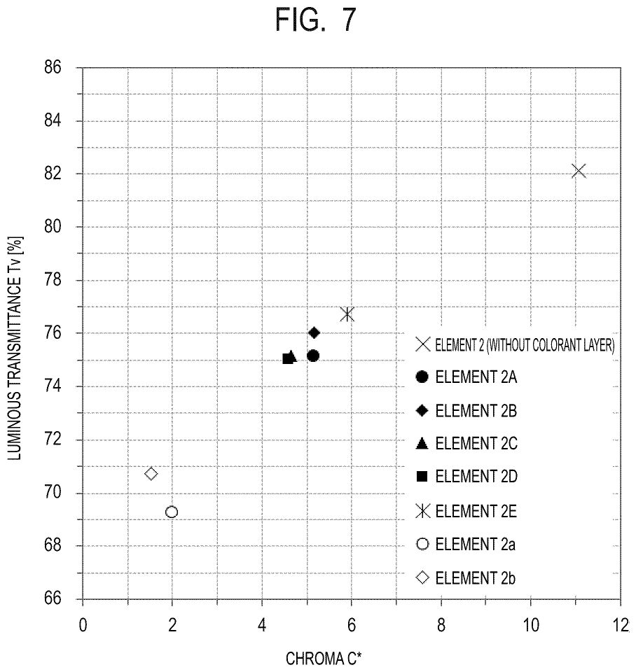

FIG. 6 shows the spectral transmittances of the element 2 without forming the colorant layer and the elements 2A, 2B, 2C, 2D, 2E, 2a, and 2b each forming the colorant layer. FIG. 7 shows the correlation between the chroma C* and the luminous transmittance Tv of these elements. Furthermore, Table 4 shows the values of the chromaticity coordinates a* and b*, the chroma C*, the hue angle h* and the luminous transmittance Tv of these elements.

TABLE 4

| | Element 2 | Element 2A | Element 2B | Element 2C | Element 2D | Element 2E | Element 2a | Element 2b |
|---|---|---|---|---|---|---|---|---|
| Colorant Layer | None | A | B | C | D | E | a | b |
| a* | −5.4 | 1.55 | −0.5 | 0.01 | 0.53 | −1.39 | 0.38 | −0.38 |
| b* | 9.66 | 4.89 | 5.13 | 4.66 | 4.55 | 5.74 | 1.94 | 1.48 |
| C* | 11.07 | 5.13 | 5.16 | 4.66 | 4.58 | 5.91 | 1.98 | 1.53 |
| h* | 119.18 | 72.37 | 95.55 | 89.84 | 83.33 | 103.57 | 78.93 | 104.22 |
| T_{V} [%] | 82.12 | 75.15 | 76.02 | 75.15 | 75.04 | 76.73 | 69.29 | 70.72 |

In the elements 2A, 2B, 2C, 2D and 2E formed with the colorant layers containing the five types of the colorants (colorants A, B, C, D, and E) in the suitable range of the absorption spectral shape defined in the above embodiment, the chroma C* could be achromatized to 4.6 to 5.9. In addition, in the elements 2A, 2B, 2C, 2D and 2E, the decrease of the luminous transmittance Tv could be suppressed as small as 5.4% to 7.1%. In the elements 2A, 2B, 2C, 2D and 2E, the luminous transmittance was 75% or more.

On the other hand, in the elements 2a and 2b formed with the colorant layers containing the two types of colorants (colorant a and b) deviating from the suitable range, although the chroma C* could be achromatized to less than 2, the luminous transmittance Tv was reduced by 11% or more.

### EXAMPLE 3

In this example, EC elements were fabricated using an ITO (GEOMATEC Co., Ltd.) having a sheet resistance of 5.8 Ω/□ as the transparent electrode and an alkali-free glass having a thickness of 700 μm as the substrate. On one substrate surface (the surface opposite to the transparent electrode), the colorant layer containing one of the five types of the colorants (colorants A, B, C, D, and E) in the suitable range of the absorption spectral shape defined in the above embodiment and the two types of the colorants (colorant a and b) deviating from the suitable range was formed. The prepared EC elements are eight types of elements including an element 3 as a comparative example, elements 3A, 3B, 3C, 3D, and 3E as examples, and elements 3a and 3b as comparative examples. No colorant layer was formed in the element 3. The colorant layer containing the colorant A was formed in the element 3A. The colorant layer containing the colorant B was formed in the element 3B. The colorant layer containing the colorant C was formed in the element 3C. The colorant layer containing the colorant D was formed in the element 3D. The colorant layer containing the colorant E was formed in the element 3E. The colorant layer containing the colorant a was formed in the element 3a. The colorant layer containing the colorant b was formed in the element 3b. Here, the absorption intensity of the colorant layer alone was adjusted so that the absorbance of all the colorants was 0.06.

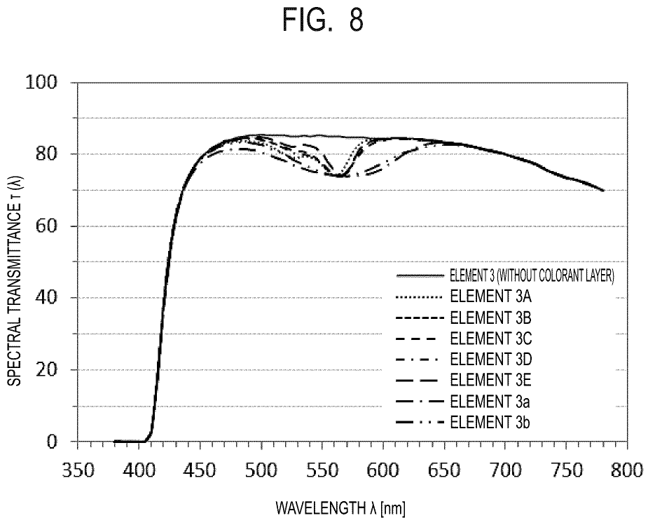

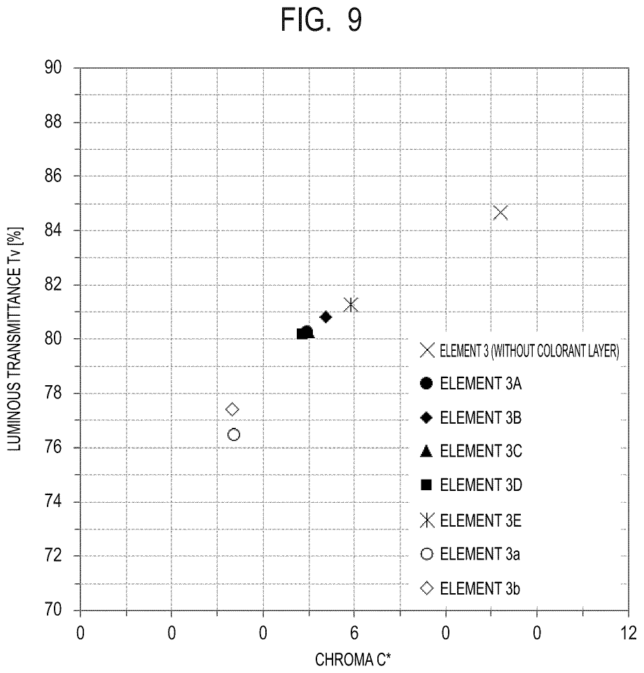

FIG. 8 shows the spectral transmittances of the element 3 without forming the colorant layer and the elements 3A, 3B, 3C, 3D, 3E, 3a and 3b each forming the colorant layer. FIG. 9 shows the correlation between the chroma C* and the luminous transmittance Tv of these elements. Furthermore, Table 5 shows the values of the chromaticity coordinates a* and b*, the chroma C*, the hue angle h* and the luminous transmittance Tv of these elements.

TABLE 5

| | Element 3 | Element 3A | Element 3B | Element 3C | Element 3D | Element 3E | Element 3a | Element 3b |
|---|---|---|---|---|---|---|---|---|
| Colorant Layer | None | A | B | C | D | E | a | b |
| a* | −4.79 | −0.54 | −1.80 | −1.49 | −1.17 | −2.34 | −1.28 | −1.73 |
| b* | 7.84 | 4.91 | 5.06 | 4.77 | 4.71 | 5.44 | 3.12 | 2.83 |
| C* | 9.19 | 4.94 | 5.37 | 5.00 | 4.85 | 5.92 | 3.38 | 3.32 |
| h* | 121.43 | 96.31 | 109.55 | 107.33 | 104.01 | 113.33 | 112.32 | 121.46 |
| T_{V} [%] | 84.68 | 80.26 | 80.82 | 80.26 | 80.19 | 81.27 | 76.46 | 77.40 |

In the elements 3A, 3B, 3C, 3D, and 3E formed with the colorant layers containing the five types of the colorants (colorants A, B, C, D, and E) in the suitable range of the absorption spectral shape defined in the above embodiment, the chroma C* can be achromatized to 4.9 to 5.9. In addition, in the elements 3A, 3B, 3C, 3D, and 3E, the decrease of the luminous transmittance Tv could be suppressed as small as 3.4% to 4.5%. The elements 3A, 3B, 3C, 3D, and 3E had the luminous transmittance of 80% or more, which exceeded the luminous transmittance of 75% or more of the elements 2A, 2B, 2C, 2D, and 2E.

On the other hand, in the elements 3a and 3b formed the colorant layers containing the two types of the colorants (colorants a and b) deviating from the suitable range, although the chroma C* could be achromatized to less than 4, the luminous transmittance Tv was reduced by more than 7% or more.

### [Applications of EC Elements, Etc.]

The EC element according to one embodiment of the present invention can be applied to a member, apparatus, device, and the like that has a dimming function. In the followings, cases in which the EC element according to one embodiment of the present invention is applied to a dimming spectacle lens and a dimming window will be described. The dimming spectacle lens is a spectacle lens having a dimming function. The dimming window is a window material having a dimming function.

### (Dimming Spectacle Lens)

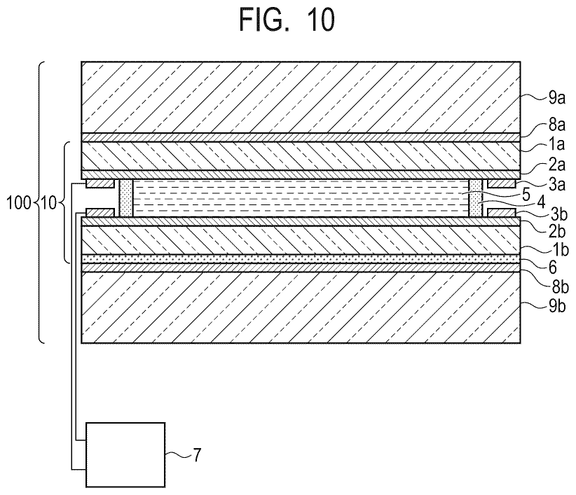

FIG. 10 is a schematic cross-sectional view illustrating a dimming spectacle lens 100 including the EC element 10 according to one embodiment of the present invention. As illustrated in FIG. 10, the dimming spectacle lens 100 includes the EC element 10, protective plates 9a and 9b, and OCAs (optical transparent adhesives) 8a and 8b. The protective plates 9a and 9b for protecting the EC element 10 from impact are affixed to the front and rear surfaces of the EC element 10 by the OCAs 8a and 8b, respectively. The dimming spectacle lens 100 including the EC element 10 is formed so as to have the shape of a prescribed spectacle lens.

As the protective plates 9a and 9b, plates that are highly transparent and have high strength and heat resistance can be preferably used. Specifically, as the protective plates 9a and 9b, for example, polyethylene terephthalate resin (PET), polycarbonate (PC), allyl diglycol carbonate resin (ADC), colorless transparent polyimide resin (PI), or the like can be used.

As the OCAs 8a and 8b, transparent adhesives molded into sheets can be preferably used. As described above, it is preferable to form or affix a member for shielding ultraviolet rays in order to prevent the deterioration of the EC layer 5 by the ultraviolet rays in the dimming spectacle lens 100. The member for shielding the ultraviolet rays is an ultraviolet reflecting film, an ultraviolet absorbing film, or the like. In addition to the ultraviolet reflecting film, the ultraviolet absorbing film, or the like, the OCAs 8a and 8b may preferably include an ultraviolet absorbing agent to make the OCAs 8a and 8b have an ultraviolet absorbing function.

The dimming spectacle lens 100 is connected to the driving circuit 7 as driving means and a battery housed in the temple part of the spectacle or the bridge part of the front frame. The dimming spectacle lens 100 can perform arbitrary dimming by adjusting the voltage applied to the EC layer 5 by the driving circuit 7 by the person wearing the dimming spectacle.

### (Dimming Window)

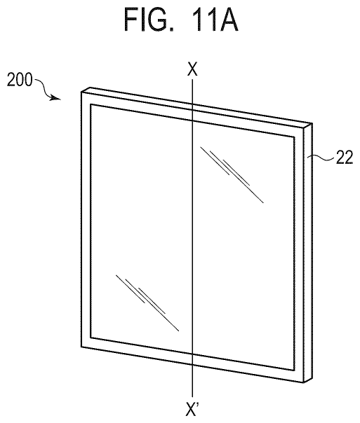

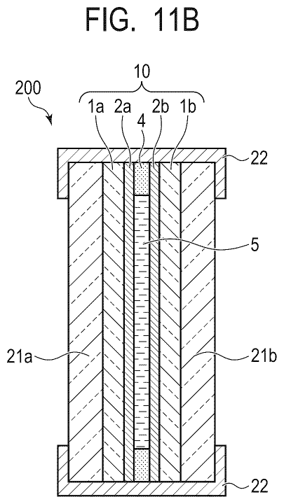

FIG. 11A is an overview view illustrating a dimming window 200 as a window material using the EC element 10 according to one embodiment of the present invention, and FIG. 11B is a schematic view illustrating an X-X′ cross-sectional view of FIG. 11A. The dimming window 200 includes the EC element 10 (optical filter), transparent plates 21a and 21b that are substrates for sandwiching the EC element 10, and a frame 22 that surrounds and integrates the entire window. The driving circuit 7 (see FIG. 1) may be integrated within the frame 22 or may be arranged outside the frame 22 and connected to the EC element 10 through wirings.

The transparent plates 21a and 21b are not particularly limited as long as they are made of a material having a high light transmittance, and are preferably made of glass in consideration of their use as windows. The frame 22 may be made of any material, but may be regarded as a frame, which generally covers at least a part of the EC element 10 and has an integrated form. In FIG. 11B, the EC element 10 is a constituent member independent of the transparent plates 21a and 21b, but for example, the substrates 1a and 1b of the EC element 10 may be regarded as the transparent plates 21a and 21b.

The dimming window 200 can be applied, for example, to adjust the amount of sunlight incident into a room during the daytime. Since the dimming window 200 can be applied to adjust the amount of heat in addition to the amount of light of the sun, the dimming window 200 can be used to control the brightness and temperature of the room. The dimming window 200 can also be used as a shutter to block the view from the outside to the room. Such a dimming window can be applied not only to glass windows for buildings but also to windows for vehicles such as cars, trains, airplanes, ships, and the like.

As described above, according to the embodiment of the present invention, by providing the colorant layer 6 containing the colorant having the above absorption spectral shape in the EC element 10, it is possible to provide the EC element 10 which is substantially achromatized while maintaining a high transmittance in a decolored state. Thereby, it is possible to provide an excellent optical dimming spectacle lens, which can be worn without choosing a scene from the nighttime to the daytime outdoors, and in which the transmittance attenuation of a specific color is not seen even in a decolored state.

### [Modification Embodiment]

Various modifications of the present invention are possible without being limited to the above embodiments.

For example, an example in which a part of a configuration of one embodiment is added to another embodiment or an example in which part of a configuration of one embodiment is replaced with a part of a configuration of another embodiment is also an embodiment of the present invention.

In the above embodiments, the examples in which the EC element according to the present invention is applied to a spectacle lens and a window material are described but the application of the EC element according to the present invention is not limited these. The EC element according to the present invention can also be applied to an optical filter, a lens unit, an imaging apparatus, an anti-glare mirror, and the like.

Note that each of the above embodiments is only an example of embodiment in carrying out the present invention, and the technical scope of the present invention should not be interpreted to be limited by these embodiments. That is, the present invention can be implemented in various forms without departing from the technical concept or its main features.

The present invention is not limited to the above embodiments, and various modifications and variations can be made without departing from the spirit and scope of the present invention. Accordingly, the following claims are attached to make the scope of the present invention public.

According to the present invention, it is possible to achieve substantial achromatization of an EC element having a color in a decolored state while suppressing a decrease in transmittance.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An electrochromic element comprising:
an element structure including a pair of electrodes and an electrochromic layer arranged between the pair of electrodes, in which a chromaticity in a decolored state is in a range of a chroma C*=6 to 15 and a hue angle h*=105° to 130° in a chromaticity diagram of a CIE 1976 color space; and
a colorant layer provided in the element structure and having a main absorption peak with an absorbance of 0.04 to 0.12 and a full width at half maximum of 20 to 60 nm between 550 nm and 570 nm in wavelength.

2. The electrochromic element according to claim 1, wherein a luminous transmittance of the electrochromic element is 75% or more.

3. The electrochromic element according to claim 1, wherein the colorant layer does not have EC characteristics.

4. The electrochromic element according to claim 1, wherein the colorant layer is a thin film formed on a substrate.

5. The electrochromic element according to claim 1, wherein the colorant layer is included in the electrochromic layer.

6. The electrochromic element according to claim 1, wherein the colorant layer includes an anodic electrochromic compound and a cathodic electrochromic compound.

7. The electrochromic element according to claim 1, wherein the colorant layer contains one of SR-8913, KJ-170, Solvent Red 49, NK-76, and Acid Red 94.

8. A spectacle lens comprising an electrochromic element, wherein the electrochromic element is the electrochromic element according to claim 1.

9. A window material comprising the electrochromic element according to claim 1.
